(19) United States
(12) Patent Application Publication
(10) Pub. No.: US 2013/0120639 A1
(43) Pub. Date: May 16, 2013

(54) IMAGING APPARATUS AND METHOD FOR CONTROLLING DIAPHRAGM

(71) Applicant: Canon Kabushiki Kaisha, Tokyo (JP)

(72) Inventor: Muneyoshi Maeda, Kawasaki-shi (JP)

(73) Assignee: CANON KABUSHIKI KAISHA, Tokyo (JP)

(21) Appl. No.: 13/671,899

(22) Filed: Nov. 8, 2012

(30) Foreign Application Priority Data
Nov. 11, 2011 (JP) 2011-247567

(51) Int. Cl. H04N 5/232

(52) U.S. Cl. CPC H04N 5/23212
USPC 348/345; 348/E05.045

(57) ABSTRACT

An imaging apparatus includes an imaging unit, a first information acquisition unit configured to acquire information on a focal length of a lens unit configured to guide light to the imaging unit, a second information acquisition unit configured to acquire information on an amount of light incident on the imaging unit, and a control unit configured to control a diaphragm configured to adjust the amount of light incident on the imaging unit, wherein the control unit is configured to determine a maximum opening value, which is used for diaphragm control of the diaphragm, based on the information on the focal length acquired by the first information acquisition unit and the information on the amount of incident light acquired by the second information acquisition unit.

### BACKGROUND OF THE INVENTION

1. Field of the Invention

The present invention relates to an imaging apparatus capable of imaging an object via a lens unit having an optical zoom function.

2. Description of the Related Art

In recent years, there is a strong demand for smaller and lighter imaging apparatuses, such as digital cameras and digital camcorders, using a high-power lens. Under such circumstances, numerical values of specifications regarding an optical zoom ratio of the lens unit are regarded as very important.

However, if the size of the lens unit is reduced and its power is increased, image quality tends to deteriorate due to, for example, aberration of the lens especially on the longer focal length side of the optical zoom (i.e., the telephoto side). For example, it is known that flare occurs due to reflection of light that enters the lens. When the flare occurs, the level of the black region in the image is raised (misadjusted black level), and a contrast of the image is reduced.

Japanese Patent Application Laid-Open No. 8-256288 discusses a method of preventing deterioration in image quality on the longer focal length side, by changing a maximum full-aperture F-number of a diaphragm, which can be controlled according to focal length information of the lens. According to this method, the aberration of the lens is reduced by reducing the aperture value of the diaphragm, and the F-number of the diaphragm, which is used for reducing the aberration of the lens, is calculated for each focal length using the optical data of the lens. Then, the aperture diameter of the diaphragm is controlled by using the obtained F-number as the maximum full-aperture F-number. According to this control, deterioration of image quality (see FIGS. 8A and 8B).

However, according to the method discussed in Japanese Patent Application Laid-Open No. 8-256288, a maximum full-aperture F-number that prioritizes prevention of image quality deterioration is set for each focal length. Accordingly, the diaphragm is controlled by using the maximum full-aperture F-number, which can control the diaphragm and is set corresponding to each focal length information at zooming. Thus, if the focal length is long, since the amount of incident light is significantly reduced by the diaphragm control, shutter speed and gain need to be controlled in obtaining appropriate exposure. Since there is a lower limit in the speed of the shutter speed according to the relation with the frame rate, if appropriate exposure is not obtained when the shutter speed is the lowest, the gain value is increased. However, if the gain value is increased, a signal-to-noise (S/N) ratio of the image will be reduced. In particular, if the scene is such that the amount of incident light is small (e.g., an indoor scene), the amount of increase in the gain value is increased, and the reduction in image quality due to increasing the gain value will have more influence on the image than the reduction in image quality due to the aberration of the lens.

### SUMMARY OF THE INVENTION

According to an aspect of the present invention, an imaging apparatus includes an imaging unit, a first information acquisition unit configured to acquire information on a focal length of a lens unit configured to guide light to the imaging unit, a second information acquisition unit configured to acquire information on an amount of light incident on the imaging unit, and a control unit configured to control a diaphragm configured to adjust the amount of light incident on the imaging unit, wherein the control unit is configured to determine a maximum opening value, which is used for control of the diaphragm, based on the information on the focal length acquired by the firsts information acquisition unit and the information on the amount of light acquired by the second information acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a schematic configuration of an imaging apparatus according to an exemplary embodiment of the present invention.

FIG. 2 is a graph illustrating correction curves used for calculating a maximum full-aperture F-number of a diaphragm according to a first exemplary embodiment of the present invention.

FIG. 3 is a graph illustrating diaphragm control considering the maximum full-aperture F-number according to the first exemplary embodiment of the present invention.

FIG. 4 is a flowchart illustrating processing of the diaphragm control according to the first exemplary embodiment of the present invention.

FIG. 5 is a graph illustrating a method for calculating the maximum full-aperture F-number according to a second exemplary embodiment of the present invention.

FIG. 6 is a graph illustrating a correction curve according to a third exemplary embodiment of the present invention.

FIG. 7 is a flowchart illustrating processing of the diaphragm control according to the third exemplary embodiment of the present invention.

FIGS. 8A and 8B are graphs illustrating a relation between the maximum full-aperture F-number and a focal length according to a conventional technique.

### DESCRIPTION OF THE EMBODIMENTS

Various exemplary embodiments, features, and aspects of the invention will be described in detail below with reference to the drawings.

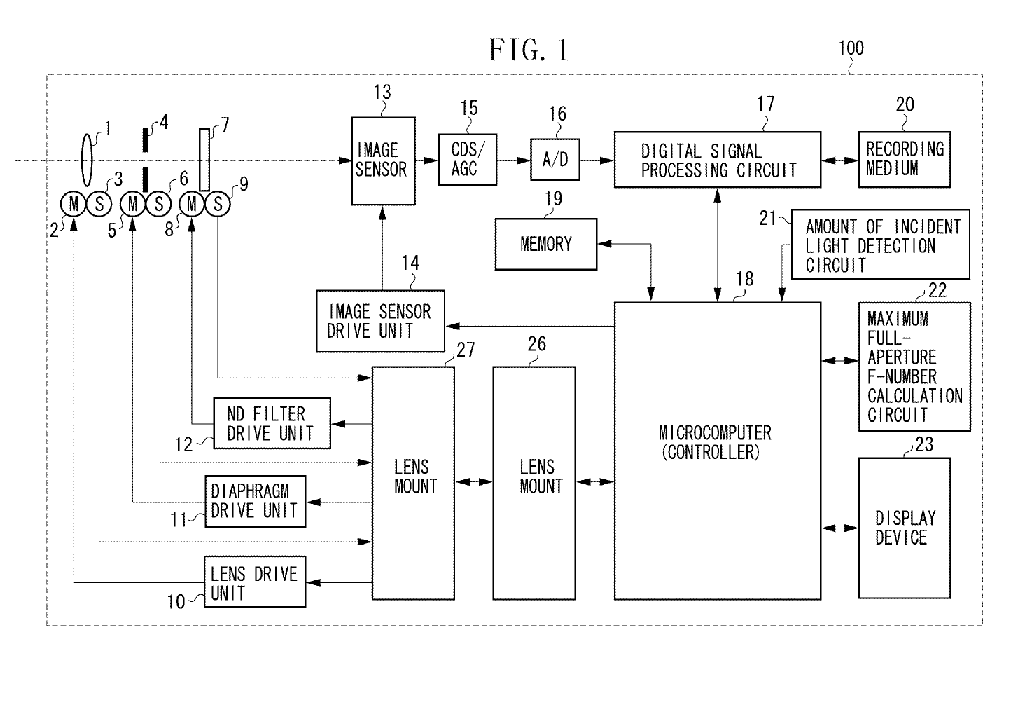

A first exemplary embodiment of the present invention will be described. FIG. 1 is a block diagram illustrating an example of a schematic configuration of an imaging apparatus 100 according to an exemplary embodiment of the present invention. The imaging apparatus 100 is an imaging apparatus such as a digital still camera or a digital camcorder, and is also an interchangeable lens type imaging apparatus having a lens unit removably mounted on a lens mount 26 of the camera main body. The imaging apparatus 100 receives a light beam that enters an image sensor 13 via a lens 1, and generates a captured image according to an instruction from a microcomputer 18 given to various circuits.

The lens 1 guides the light beam, which enters the imaging apparatus 100 from outside, to the inside of the imaging apparatus 100. Although the lens 1 includes a single lens in FIG. 1 to simplify the description, it may include a plurality of lenses.

A lens drive motor 2 controls the focal length of the lens 1 by driving the lens 1 in an optical axis direction according to the drive power supplied from a lens drive unit 10. A lens state detection circuit 3 detects the drive state of the lens 1 and outputs the detected information of the focal length of the lens 1 to the microcomputer 18. Although the imaging apparatus having the lens drive motor 2 to drive the lens 1 is described in the present exemplary embodiment, the imaging apparatus may be configured such that the lens 1 is driven by a manual operation. If the lens 1 is manually driven, the lens drive motor 2 and the lens drive unit 10 are not necessary. Even if the lens operation is manually performed, the lens state detection circuit 3 detects the drive state such as the focal length of the lens 1.

A diaphragm 4 has blades used for adjusting the quantity of incident light. A diaphragm drive motor 5 drives the diaphragm 4 according to the drive power supplied from a diaphragm drive unit 11. The diaphragm drive unit 11 calculates the drive power to be supplied to the diaphragm 4 based on a drive amount and a drive speed of the diaphragm, which are obtained from the microcomputer 18. A diaphragm state detection circuit 6 detects a drive state of the diaphragm 4 and outputs the detection result to the microcomputer 18.

A neutral density (ND) filter 7 attenuates the light incident through the lens 1. A ND filter drive motor 8 moves the ND filter 7 according to the drive power supplied from a ND filter drive unit 12. Although one ND filter is included as the ND filter 7 in FIG. 1 to simplify the illustration, a plurality of ND filters with different density may be included.

A ND filter state detection circuit 9 detects the drive state of the ND filter 7 and outputs the result of the detection to the microcomputer 18. According to the present exemplary embodiment, although the imaging apparatus having the ND filter 7 to be driven by the ND filter drive motor 8 is described, an imaging apparatus having a fixed ND filter 7 or an imaging apparatus without an ND filter 7 may be used. If the ND filter 7 of the imaging apparatus is fixed, or if the imaging apparatus does not include the ND filter 7, the ND filter drive motor 8 and the ND filter drive unit 12 are not necessary. Even if the ND filter is operated manually, the drive state of the ND filter 7 is detected by the ND filter state detection circuit 9.

The image sensor 13 performs imaging of an object. According to the present exemplary embodiment, the image sensor 13 includes an X-Y address type complementary metal-oxide semiconductor (CMOS) image sensor. However, it may include a charge-coupled device (CCD) image sensor. A correlated double sampling (CDS)/auto gain control (AGC) circuit 15 performs sampling and amplification of an image signal based on the charge accumulated on each pixel of the image sensor 13. The sampling to be performed is correlated double sampling and the amplification to be performed is auto gain control. An analog-to-digital (A/D) converter 16 converts an analog image signal output from the CDS/AGC circuit 15 into a digital image signal. A digital signal processing circuit 17 performs various types of signal processing regarding the digital image signal output from the A/D converter 16.

A microcomputer (hereinafter also referred to as a controller) 18 performs overall control of the operations of the imaging apparatus 100. For example, the controller 18 receives information of, for example, luminance or color from the digital signal processing circuit 17 and performs various types of calculation processing and data communication with each processing unit.

A maximum full-aperture F-number calculation circuit 22 calculates a maximum full-aperture F-number (a maximum opening value of the diaphragm 4) used for diaphragm control based on information of a focal length transmitted from the lens state detection circuit 3 and information of the amount of incident light acquired by an amount of incident light detection circuit 21 described below. In calculating the maximum full-aperture F-number used for the diaphragm control, a table which provides a maximum full-aperture F-number, which is calculated from the information of the focal length and the amount of incident light recorded in a memory 19, is used. If such a table is not provided, the maximum full-aperture F-number used for the diaphragm control can be obtained using interpolation corresponding to an amount of incident light obtained from the two curves of maximum full-aperture F-number, which corresponds to each focal length and is stored in the memory 19. The maximum opening value of the diaphragm 4 is a maximum value of the opening values of the diaphragm 4 used for the diaphragm control. According to the diaphragm control, the opening value of the diaphragm 4 is controlled in a range the opening value does not exceed the maximum opening value according to the brightness of the object.

The lens drive unit 10 supplies drive power to the lens drive motor 2 by the control of the controller 18. For example, when the controller 18 receives a command that instructs a change in the focal length, the lens drive unit 10 supplies drive power that moves the lens 1 in the optical axis direction. In this manner, the focal length can be controlled.

The diaphragm drive unit 11 supplies drive power to the diaphragm drive motor 5 by the control of the controller 18. For example, the diaphragm drive unit 11 supplies drive power that closes or opens the diaphragm 4 by the control of the controller 18 corresponding to a light metering value (luminance value) of the image captured by the image sensor 13. Accordingly, the diaphragm is controlled and an appropriate quantity of light enters the image sensor 13.

The ND filter drive unit 12 supplies drive power to the ND filter drive motor 8 by the control of the controller 18. For example, the ND filter drive unit 12 supplies drive power to increase or reduce the amount of attenuation of the light that enters the ND filter 7, by the control of the controller 18 corresponding to the light metering value of the image captured by the image sensor 13. In this manner, the attenuation of the light that enters the image sensor 13 is controlled according to the light metering value of the captured image.

The lens drive unit 10, the diaphragm drive unit 11, and the ND filter drive unit 12 are controlled by the controller 18 via the lens mount 26 on the camera side and a lens mount 27 on the lens side.

Based on the control by the controller 18, an image sensor drive unit 14 supplies a drive pulse for driving the image sensor 13 to the image sensor 13. According to the drive pulse, the image sensor 13 reads out the captured image and controls the exposure time (charge accumulation time) . For example, the image sensor drive unit 14 supplies a drive pulse to be used for the exposure of the image sensor 13 by the control performed by the controller 18 according to the light metering value of the image captured by the image sensor 13. In this manner, the imaging apparatus controls the exposure time of the image sensor 13 according to the light metering value of the captured image.

The memory 19 is a random access memory (RAM) or the like used for temporarily and/or permanently storing data. For example, the memory 19 temporarily stores the image data captured by the image sensor 13; this image data temporarily stored in memory 19 will then undergo pertinent processing performed by the digital signal processing circuit 17. Further, a program for driving the imaging apparatus 100 is stored in the memory 19. The program is sequentially invoked and executed by the controller 18. A recording medium 20, such as a removable memory card or the like, stores the image data processed by the digital signal processing circuit 17.

The amount of incident light detection circuit 21 (first information acquisition unit) detects the amount of incident light from the luminance information of the image data obtained by the imaging performed by the image sensor 13, and the information of the amount of incident light as a detection result is transmitted to the controller 18. A display device 23 displays an image based on the image data processed by the digital signal processing circuit 17. According to the present exemplary embodiment, each unit is independently described as illustrated in FIG. 1. However, some of the processing performed by each unit illustrated in FIG. 1, for example, the processing regarding the acquisition of the focal length information or the processing regarding the acquisition of the information of the amount of incident light can be collectively executed by the controller 18.

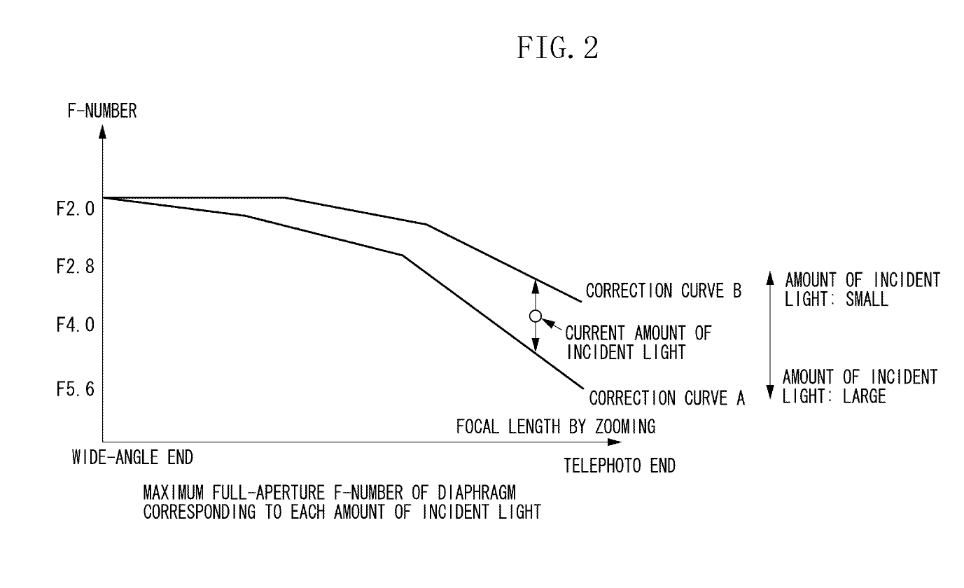

Next, the processing of the diaphragm control performed by the imaging apparatus 100 according to the present embodiment will be described with reference to FIGS. 2, 3, and 4.

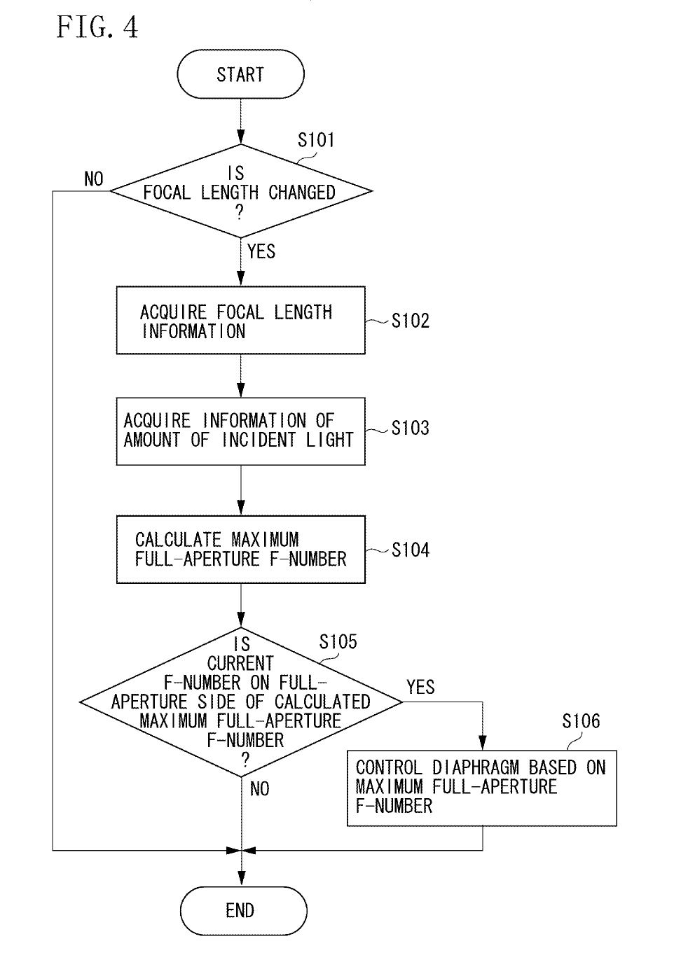

The flowchart illustrated in FIG. 4 is assumed to begin (START) after the imaging apparatus 100 has been placed in a default operational state (e.g., ready to obtain an image) . In this state, at step S101, the controller 18 determines whether the focal length is changed by a user operating an operation unit (not illustrated). If the controller 18 determines that the focal length is not changed (NO in step S101), since it is not necessary to calculate a new maximum full-aperture F-number, the processing of the flowchart ends. If the controller 18 determines that the focal length is changed (YES in step S101), the processing proceeds to step S102. In step S102, the lens state detection circuit 3 acquires information of the focal length (hereinafter also referred to as focal length information), and the processing proceeds to step S103. Then, in step S103, the amount of incident light detection circuit 21 (second acquisition unit) acquires information on the amount of light incident on the image sensor 13, and the processing proceeds to step S104. In order to acquire the latest amount of incident light, although the amount of incident light detection circuit 21 acquires the information of the amount of incident light from the luminance information of the object whose image is captured by the image sensor 13 after the focal length is changed, the information of the amount of incident light may be acquired from the luminance information of the object whose image is captured by the image sensor 13 before the focal length is changed.

In step S104, based on the focal length information and the information of the amount of incident light acquired in steps S102 and S103, the maximum full-aperture F-number calculation circuit 22 calculates the maximum full-aperture F-number (maximum opening amount) for the diaphragm 4, which can be so controlled. When the maximum full-aperture F-number calculation circuit 22 calculates the maximum full-aperture F-number, the maximum full-aperture F-number calculation circuit 22 refers to two correction curves, which are used for calculating the maximum full-aperture F-number. An example of the correction curves is illustrated in FIG. 2, these curves may be stored in memory 19. A correction curve A is used to prioritize the prevention of the reduction of image quality due to, for example, the flare which occurs by lens aberration. The correction curve A indicates a large correction amount of the diaphragm, which corresponds to an environment such as an outdoor scene where the amount of incident light is large. A correction curve B is used to prioritize the prevention of the reduction of image quality due to increased gain value over the reduction of image quality due to the lens aberration. The correction curve B indicates a small correction amount of the diaphragm, which corresponds to an environment such as an indoor scene where the amount of incident light is small.

The maximum full-aperture F-number calculation circuit 22 calculates a correction curve with respect to the current amount of incident light by interpolating the two correction curves A and B based on the information of the amount of incident light acquired by the amount of incident light detection circuit 21. Then, based on the focal length information, which is acquired by the lens state detection circuit 3, and the obtained correction curve, the maximum full-aperture F-number of the diaphragm corresponding to the current focal length is calculated.

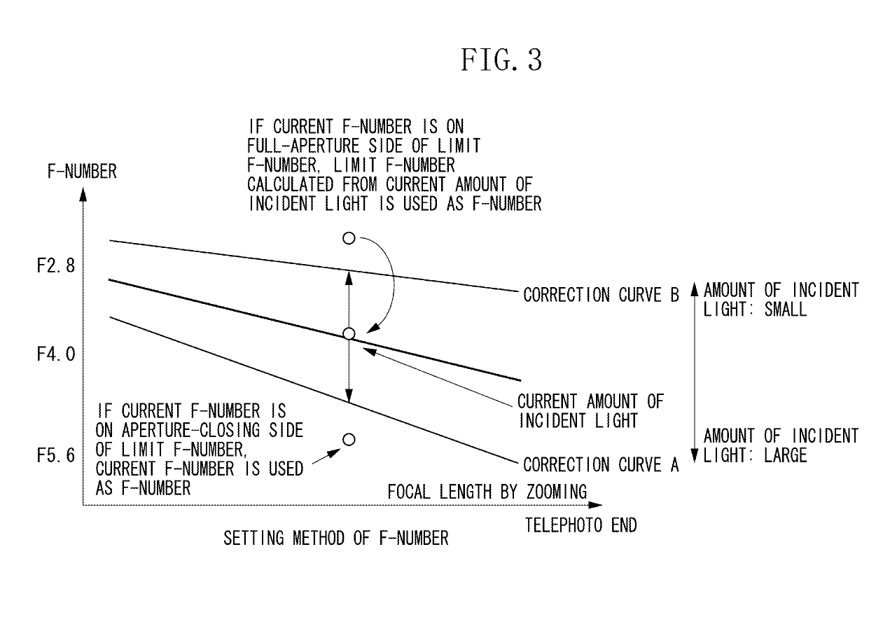

In step S105, as illustrated in FIG. 3, the controller 18 compares the current F-number of the diaphragm and the maximum full-aperture F-number calculated in step S104. If the controller 18 determines that the current F-number is on the full-aperture side of the maximum full-aperture F-number (YES in step S105), the processing proceeds to step S106. In step S106, the diaphragm drive unit 11 performs diaphragm control so that, for example, the current F-number is made equal to the obtained maximum full-aperture F-number. Alternatively, in step S106, the diaphragm is not necessarily controlled such that the current F-number is equal to the maximum full-aperture F-number. Instead, a different F-number may be used for the current F-number so long as the opening value of the diaphragm is equal to or smaller than the maximum opening value and the F-number is approximately equal to the maximum full-aperture F-number. If the controller 18 determines that the current F-number is not on the full-aperture side of the maximum full-aperture F-number (NO in step S105), the current F-number is maintained, and the processing of the flowchart illustrated in FIG. 4 ends.

As described above, according to the present exemplary embodiment, the maximum opening value of the diaphragm used for controlling the opening of the diaphragm is determined based on the information of the focal length and the information of the amount of incident light. However, in order to effect a change in the opening of the diaphragm, a change in either the information of the focal length or the information of the amount of incident light does not need to occur. Specifically, if the focal length is not changed, the maximum opening value regarding the amount of incident light of a second light quantity, which is smaller than a first light quantity, is increased compared to a case where the amount of incident light is the first light quantity. Further, if the amount of incident light is not changed, the maximum opening value regarding a second focal length, which is shorter than a first focal length, is relatively increased compared to a case where the focal length is the first focal length. In other words, by calculating the appropriate correction curve according to the imaging environment to determine the maximum full-aperture F-number, good diaphragm control useful for preventing reduction in image quality can be performed.

Next, a second exemplary embodiment will be described. According to the first exemplary embodiment, by interpolating the two correction curves according to the amount of incident light, the maximum full-aperture F-number which is useful for controlling the diaphragm is obtained. In contrast, according to the second exemplary embodiment, a method that can determine the maximum full-aperture F-number without interpolating the two correction curves will be described. Since a configuration of an imaging apparatus according to the present embodiment is similar to those of the first exemplary embodiment, description is not repeated.

Further, according to the present exemplary embodiment, only the method for calculating the maximum full-aperture F-number in step S104 illustrated in the flowchart in FIG. 4 is different from the processing in the first exemplary embodiment.

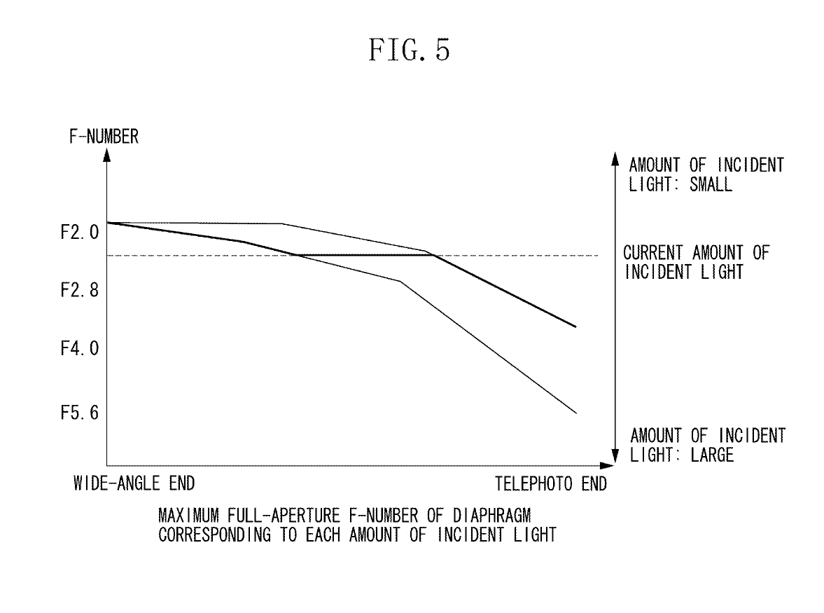

According to the present embodiment, in step S104 in the flowchart illustrated in FIG. 4, the maximum full-aperture F-number which can be controlled by the current amount of incident light is determined as illustrated in FIG. 5. For example, as illustrated in FIG. 5, the maximum full-aperture F-number calculation circuit 22 sets a reference value (illustrated with a dotted line) corresponding to the current amount of incident light. If the reference value does not exist between the two correction curves, the F-number of the correction curve which is closer to the reference value is used as the maximum full-aperture F-number. If the reference value exists between the two correction curves, the reference value is regarded as the maximum full-aperture F-number.

According to the above-described method, a limit F-number can be determined considering the imaging environment, and as is achieved by the method described in the first exemplary embodiment, good diaphragm control which is useful for preventing the reduction in image quality can be performed.

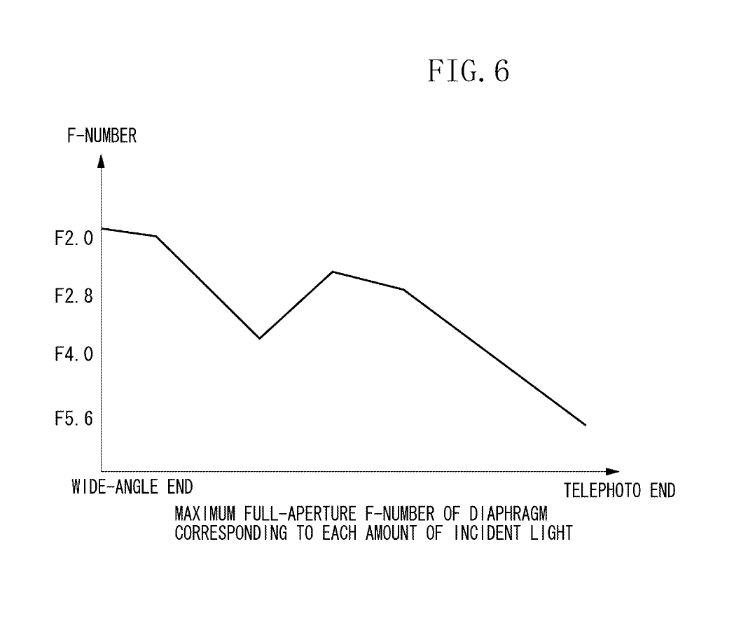

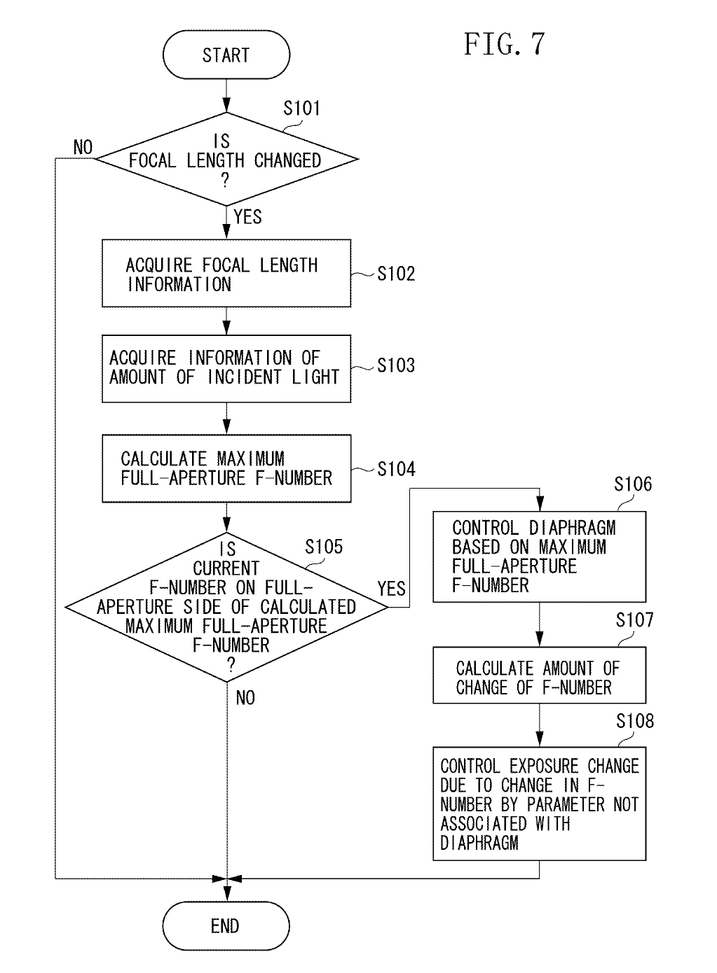

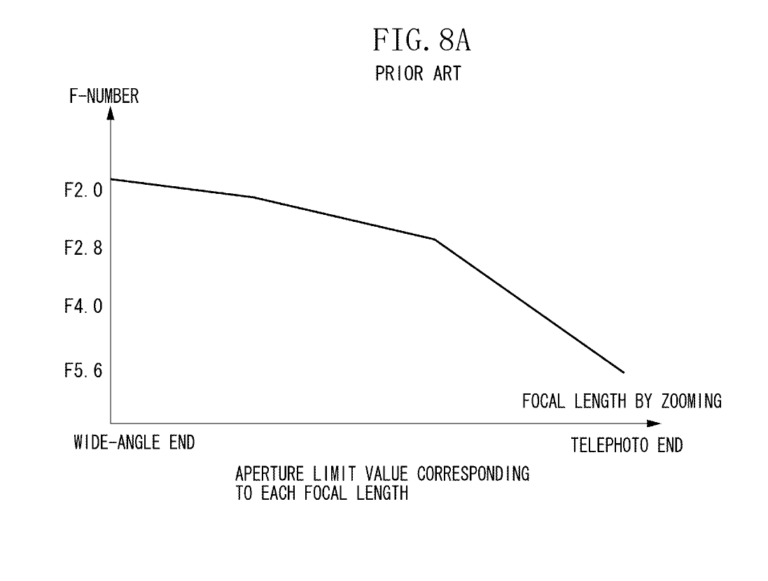

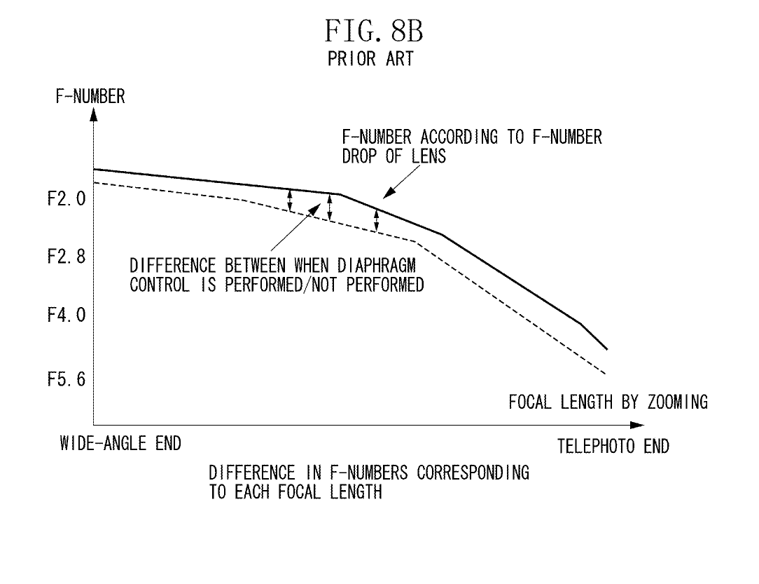

Next, a third exemplary embodiment will be described. According to the first and the second exemplary embodiments, a case is considered where the maximum full-aperture F-number is shifted to the side opposite the full-aperture side when the focal length is increased. However, as illustrated in FIG. 6, the opening value may need to be greatly reduced in the intermediate position of the focal lengths depending on design of the lens. In such a case, the brightness is rapidly reduced when the focal length is increased. Thus, according to the third exemplary embodiment, a method that prevents the brightness from rapidly being reduced by the diaphragm control according to the change in the focal length when the correction curve greatly drops on the side opposite the full-aperture side in the intermediate position of the focal length will be described with reference to FIG. 7. Since a configuration of the imaging apparatus according to the third exemplary embodiment is similar to those of the first and the second exemplary embodiments, their description is not repeated.

Since processes performed in steps S101 to S106 in FIG. 7 are similar to those having the same step numbers in FIG. 4 of the first exemplary embodiment, their descriptions are not repeated. In step S107, the controller 18 calculates the amount of change of the F-number regarding the diaphragm control in step S106. Then, in step S108, the controller 18 performs control, which is different from the diaphragm control, based on the amount of change of the F-number calculated in step S107, to reduce the change in the exposure by the diaphragm control performed in step S106.

The control which is different from the diaphragm control includes, for example, shutter speed control, gain control, and ND filter control. Whether to employ such control to perform the correction may be determined by the mode or the imaging environment of the imaging apparatus. For example, if the imaging apparatus is set to a shutter speed priority (a TV priority) mode, the change in exposure may be reduced by employing control other than the shutter speed control. Additionally, if the imaging apparatus is used indoors with a small amount of incident light, the change in exposure may be reduced by employing control other than the gain control.

As described above, by employing control which is different from the diaphragm control to compensate the change amount in exposure, which occurs when good diaphragm control for preventing the reduction in image quality is performed, good exposure control can be achieved while preventing the reduction in image quality.

The present invention is not limited to the above-described exemplary embodiments, and various changes and modifications can be applied so long as they fall within the scope of the present invention. For example, although an interchangeable lens type imaging apparatus is used in describing the embodiments, an imaging apparatus integrating a lens unit can also be used.

Further, according to the above-described exemplary embodiments, although the maximum full-aperture F-number is calculated using the correction curves, if a table that associates a combination of the amount of incident light and the focal length with a maximum full-aperture F-number is stored in advance in, for example, the memory 19, the maximum full-aperture F-number may be obtained from the table.

Further, in the above-described exemplary embodiments, if the amount of incident light is within a predetermined range, the maximum opening value of the diaphragm used for the diaphragm control may be determined based on the information of the focal length and the information of the amount of incident light. According to such configuration, if the focal length is not changed, the maximum opening value is set to the opening value where the amount of incident light is at the upper limit if the amount of incident light is greater than the upper limit of the predetermined range. Further, the maximum opening value is set to the opening value where the amount of incident light is at the lower limit if the amount of incident light is smaller than the lower limit of the amount of incident light.

According to the above-described exemplary embodiment, if the brightness of the object is changed and the object becomes brighter, the control for fully opening the aperture may be prioritized over the control for increasing the gain, and the above-described predetermined range may be set within the range of the amount of incident light corresponding to the brightness regarding the control for increasing the gain value. In other words, the upper limit and the lower limit of the above-described predetermined range may be set to a small light amount that requires an increase in the gain value by fully opening the aperture of the diaphragm.

Further, the imaging apparatus may be configured to combine a portion of the above-described exemplary embodiments.

Further, the exemplary embodiments of the present invention includes a case where a software program, which realizes the functions of the above-described exemplary embodiments, is supplied to a system or an apparatus including a computer capable of executing such a program directly from a recording medium or via wired/wireless communication, and where the software program is executed by the computer. Thus, the program code itself which is supplied and installed in the computer to realize the functions and the processing of the exemplary embodiments of the present invention on the computer also constitutes the exemplary embodiments of the present invention. In other words, the computer-executable program itself configured to realize the functions and the processing of the exemplary embodiments of the present invention constitutes the exemplary embodiments of the present invention. In such a case, as long as the function of the program is implemented, any form of the program, for example, object code, a program implemented by an interpreter, or script data to be supplied to an operating system (OS) may be employed. A recording medium used for supplying the program may include, for example, a hard disk, a magnetic recording medium such as a magnetic tape, an optical/magneto-optical storage medium, and a non-volatile semiconductor memory. The computer-executable program which realizes the exemplary embodiments of the present invention may be supplied to a server to be stored therein on a computer network, and a client computer which is connected to the server may download the computer-executable program to use it.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-247567 filed Nov. 11, 2011, which is hereby incorporated by reference herein in its entirety.

What is claimed is:

1. An imaging apparatus comprising:
an imaging unit;
a first information acquisition unit configured to acquire information on a focal length of a lens unit configured to guide light to the imaging unit;
a second information acquisition unit configured to acquire information on an amount of light incident on the imaging unit; and
a control unit configured to control a diaphragm configured to adjust the amount of light incident on the imaging unit,
wherein the control unit is configured to determine a maximum opening value, which is used for control of the diaphragm, based on the information on the focal length acquired by the first information acquisition unit and the information on the amount of light acquired by the second information acquisition unit.

2. The imaging apparatus according to claim 1, wherein, if the focal length based on the acquired information on the focal length is not changed, compared to a case where the amount of incident light based on the acquired information on the amount of incident light is a first light quantity, the control unit is configured to increase the maximum opening value in a case where the amount of incident light based on the acquired information on the amount of incident light is a second light quantity, which is smaller than the first light quantity.

3. The imaging apparatus according to claim 2, wherein, if the amount of incident light based on the acquired information on the amount of incident light is not changed, compared to a case where the focal length based on the acquired information on the focal length is a first focal length, the control unit is configured to increase the maximum opening value in a case where the focal length based on the acquired information on the focal length is a second focal length, which is shorter than the first focal length.

4. The imaging apparatus according to claim 2, wherein, if the amount of incident light based on the acquired information on the amount of incident light is within a predetermined range, the control unit is configured to determine, based on the acquired information on the focal length acquired by the focal length information acquisition unit and the acquired information on the amount of incident light acquired by the amount of incident light information acquisition unit, the maximum opening value used for the diaphragm control of the diaphragm.

5. The imaging apparatus according to claim 4, wherein, if the focal length based on the acquired information on the focal length is not changed, and, if the amount of incident light based on the acquired information on the amount of incident light is greater than an upper limit of the predetermined range, the control unit is configured to change the maximum opening value so as to be equal to the maximum opening value in the case where the amount of incident light based on the acquired information on the amount of incident light is at the upper limit.

6. The imaging apparatus according to claim 4, wherein, if the focal length based on the acquired information on the focal length is not changed, and, if the amount of incident light based on the acquired information on the amount of incident light is smaller than a lower limit of the predetermined range, the control unit is configured to change the maximum opening value so as to be equal to the maximum opening value in the case where the amount of incident light based on the acquired information on the amount of incident light is at the lower limit.

7. The imaging apparatus according to claim 1, wherein the control unit is configured to control the opening value of the diaphragm in a range, which does not exceed the maximum opening value, according to brightness of an object.

8. The imaging apparatus according to claim 1, wherein the amount of incident light information acquisition unit is configured to acquire the information on the amount of incident light based on an image signal output from the imaging unit.

9. The imaging apparatus according to claim 1, wherein, if the opening value of the diaphragm is to be changed according to the determination of the maximum opening value, the control unit is configured to perform control, which is different from the diaphragm control, such that an exposure change amount due to the change of the opening value of the diaphragm is compensated.

10. A method for controlling a diaphragm of an imaging apparatus, the method comprising:
acquiring information on a focal length of a lens unit configured to guide light to an imaging unit;
acquiring information on an amount of light incident on the imaging unit;
controlling the diaphragm to adjust the amount of light incident on the imaging unit; and
determining a maximum opening value used for controlling the diaphragm based on the acquired information on the focal length and the acquired information on the amount of light.
